(19) United States
(12) Patent Application Publication
(10) Pub. No.: US 2005/0032426 A1
(43) Pub. Date: Feb. 10, 2005

(54) Connector having a simple structure assuring a stable mounting operation

(75) Inventor: Yukitaka Tanaka, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Japan Aviation Electronics Industry, Limited, Tokyo (JP)

(21) Appl. No.: 10/912,803

(22) Filed: Aug. 6, 2004

(30) Foreign Application Priority Data
Aug. 7, 2003 (JP) 288682/2003

(51) Int. Cl. H01R 9/05

(52) U.S. Cl. 439/607

(57) ABSTRACT

A connector to be mounted to a board includes a contact having an angled portion, a housing having a fitting portion and fixedly holding the contact, and a conductive shell. The shell includes a front shell covering the fitting portion and a back shell covering the angled portion. The front shell has a terminal to be connected to the board and a fixing portion provided with an insertion hole allowing a screw to be inserted therethrough. The back shell has a terminal to be connected to the board and a fixed portion faced to the fixing portion. The fixed portion has a tap portion. The front and the back shells are fixed to the housing by screwing the screw through the insertion hole into the tap portion.

This application claims priority to prior Japanese patent application JP 2003-288682, the disclosure of which is incorporated herein by reference.

### BACKGROUND OF THE INVENTION

This invention relates to a connector having an electromagnetic shielding function and adapted to be mounted on a board such as a printed circuit board known in the art.

A connector of the type is disclosed, for example, in U.S. Pat. No. 6,554,642 as an electrical connector. The electrical connector comprises an insulator housing surrounded by a back shell and a front shell which are made of conductive members, respectively. The back shell and the front shell are electrically connected to each other through mechanical contact at their portions. The front shell has a tap portion fixed via a screw to a casing panel or a chassis panel of an electric or electronic apparatus.

When the electrical connector is mounted to a circuit board, the electrical connector is electrically connected to the circuit board by the use of a grounding member. However, since the grounding member is required, the number of components is increased and assembling requires a lot of time and labor (a number of steps), resulting in an increase in cost.

When the electrical connector is attached to the panel, the front shell is pulled towards the chassis panel and applied with a load. If a connecting strength between the front shell and the housing or a connecting strength between the front shell and the back shell is weak, the front shell may possibly be released.

Further, the back shell is not terminated at the circuit board but a separate component connected to the front shell is terminated at the circuit board. Therefore, a grounding signal is difficult to flow towards the back shell. Further, the grounding signal flowing from the front shell may be reflected at an end portion of the back shell. In addition, if the contact between the front shell and the separate component is insufficient, an electrically stable loop can not be obtained. In this event, reflection may also occur at an end portion of the front shell. Such reflection causes electromagnetic interference to induce a noise.

### SUMMARY OF THE INVENTION

It is therefore an object of the present invention to provide a connector having a simple structure assuring a stable operation of mounting the connector to a circuit board and a stable operation of attaching the connector to a chassis panel.

It is another object of the present invention to provide a connector which is enhanced in connecting strength between a front shall and a back shell.

It is still another object of this invention to provide a connector sufficiently enhanced in shielding function.

Other objects of the present invention will become clear as the description proceeds.

According to an aspect of the present invention, there is provided a connector to be mounted to a board, the connector comprising a contact having an angled portion, a housing having a fitting portion and fixedly holding the contact, and a shell being conductive, the shell including a front shell covering the fitting portion and a back shell covering the angled portion, the front shell having a terminal to be connected to the board and a fixing portion provided with an insertion hole allowing a screw to be inserted therethrough, the back shell having a terminal to be connected to the board and a fixed portion faced to the fixing portion, the fixed portion having a tap portion, the front and the back shells being fixed to the housing by screwing the screw through the insertion hole into the tap portion.

### BRIEF DESCRIPTION OF THE DRAWING

FIG. 1A is a front, top, and right side perspective view of a connector according to an embodiment of the present invention;

FIG. 1B is a rear, top, and left side perspective view of the connector in FIG. 1A;

FIG. 1C is a rear, bottom, and left side perspective view of the connector in FIG. 1A;

FIG. 2A is a front view of a front shell contained in the connector illustrated in FIGS. 1A to 1C;

FIG. 2B is a side view of the front shell in FIG. 2A;

FIG. 2C is a plan view of the front shell in FIG. 2A;

FIG. 3A is a front, top, and right side perspective view of a back shell contained in the connector illustrated in FIGS. 1A to 1C;

FIG. 3B is a rear, top, and left side perspective view of the back shell in FIG. 3A;

FIG. 3C is a front view of the back shell in FIG. 3A;

FIG. 3D is a right side view of the back shell in FIG. 3A;

FIG. 3E is a partially cut-away plan view of the back shell in FIG. 3A;

FIG. 3F is a rear view of he back shell in FIG. 3A;

FIG. 4A is a perspective view of the connector as seen from a front side when the connector is attached to a chassis panel;

FIG. 4B is a perspective view similar to FIG. 4A but as seen from a rear side;

FIG. 5A is an enlarged perspective view corresponding to FIG. 4B with an electric current flow depicted by white arrows;

FIG. 5B is a side view of the connector when it is attached to the chassis panel with an electric current flow similarly depicted by thick solid lines;

FIG. 6A is a front view of a modification of the front shell;

FIG. 6B is a side view of the modification of the front shell;

FIG. 6C is a bottom view of the modification of the front shell;

FIG. 7A is a front, top, and right side perspective view of a modification of the back shell;

FIG. 7B is a rear, top, and left side perspective view of the modification of the back shell; and

FIG. 7C is a view similar to FIG. 7B with a part cut away.

### DESCRIPTION OF THE PREFERRED EMBODIMENT

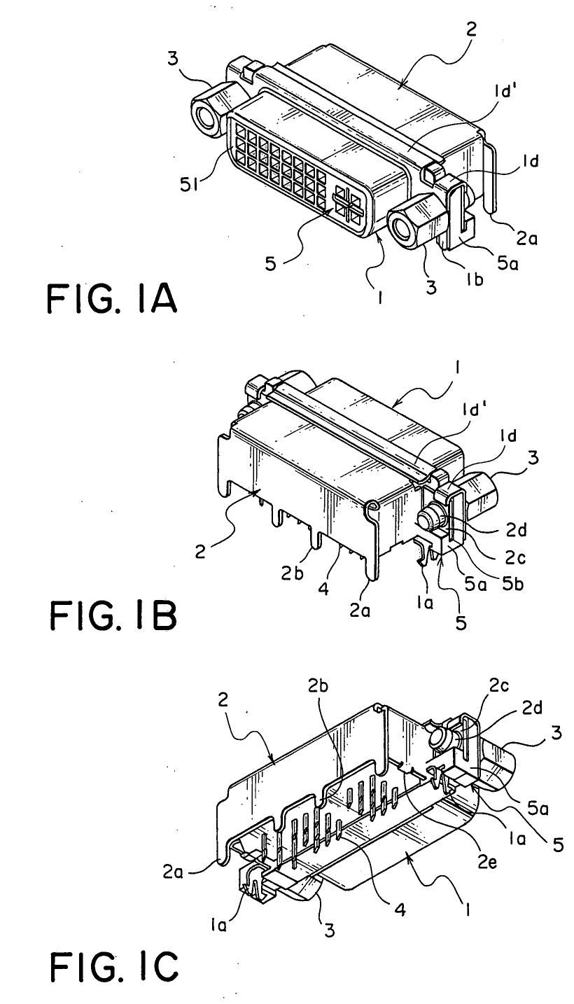

Referring to FIGS. 1A to 1C, description will be made of a whole of a connector according to an embodiment of this invention.

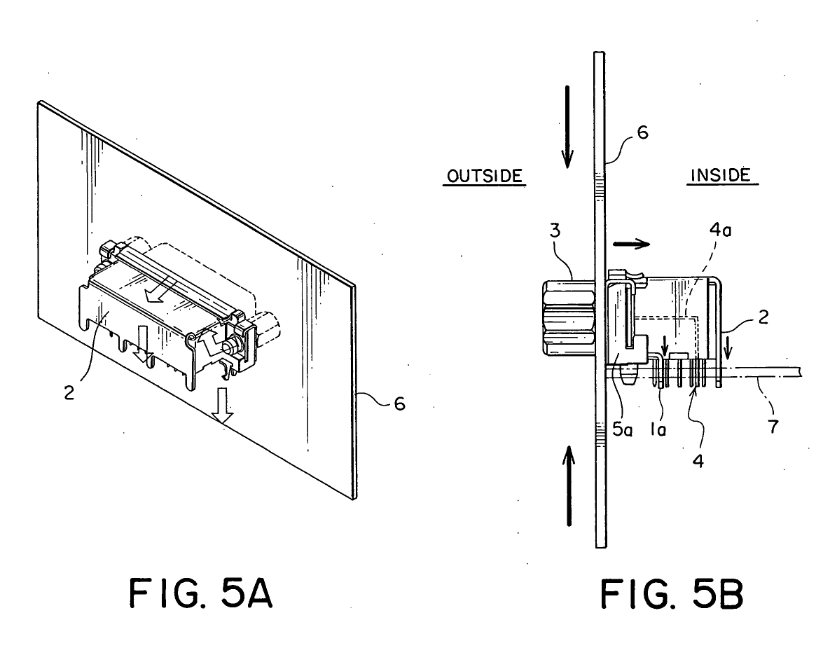

The connector illustrated in the figures comprises a plurality of conductive contacts 4 and an insulating housing 5 fixedly holding the contacts 4. The housing 5 has a fitting portion 51 covered by a conductive front shell 1. Each of the contacts 4 has an angled portion 4a covered with a conductive back shell 2, as also illustrated in FIG. 5B. The connector is mounted to a board such as a printed circuit board 7 as shown in FIG. 5B.

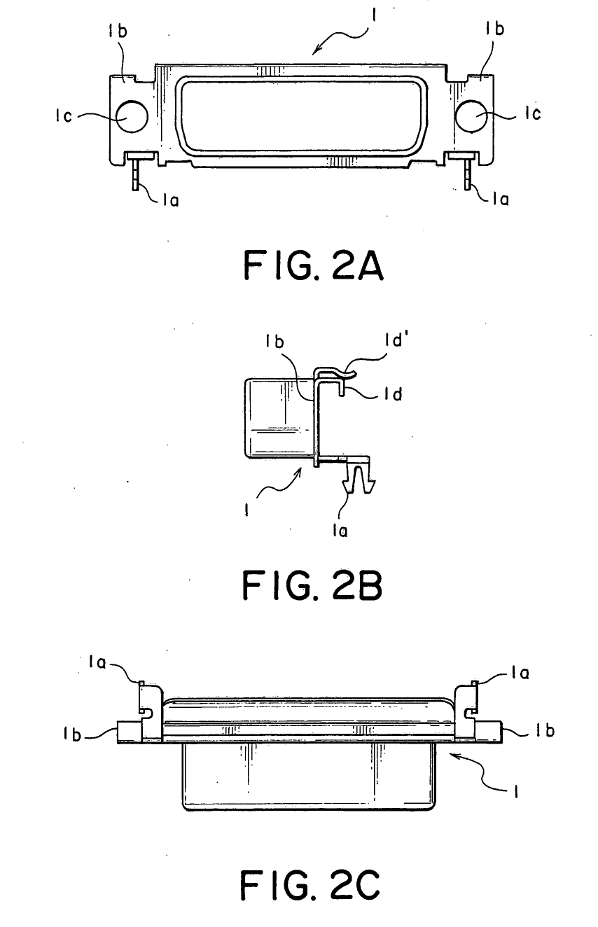

Referring to FIGS. 2A to 2C in addition, the front shell 1 has a pair of hooked terminals 1a and a pair of fixing portions 1b integrally formed on opposite sides thereof. The hooked terminals 1a are adapted to be connected to the circuit board 7. Each of the fixing portions 1b has an insertion hole 1c for inserting a screw 3. The front shell 1 is provided with a pair of lower contacting pieces 1d at the opposite sides and with an upper contacting piece 1d′ between the opposite sides. The lower and the upper contacting pieces 1d and 1d′ are integrally formed on an upper part of the front shell 1 to be elastically connected to the back shell 2. A combination of the contacting pieces 1d and 1d′ will be called a contacting portion. Each of the hooked terminals 1a of the front shell 1 has a hook portion integrally formed and adapted to be engaged with the circuit board 7.

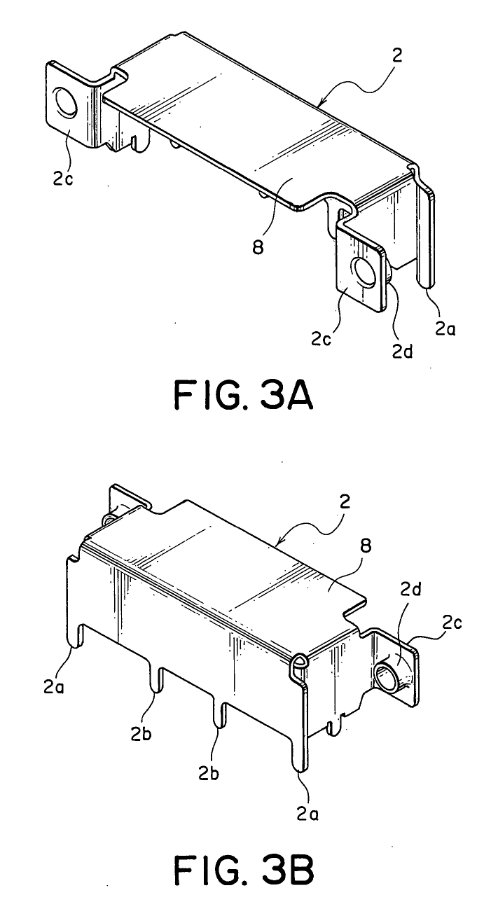

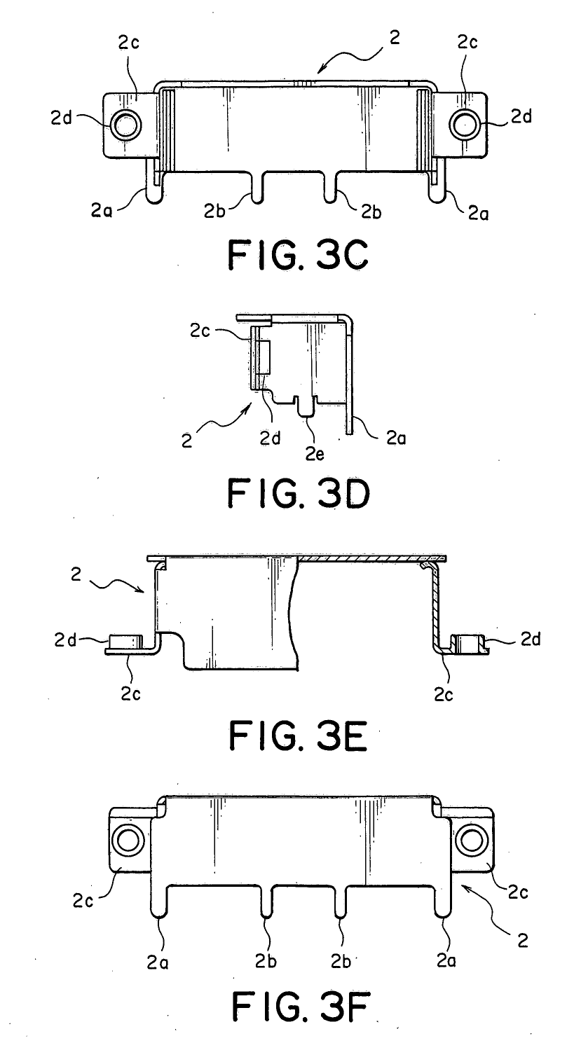

Referring to FIGS. 3A-3F, the back shell 2 has a pair of wide terminals 2a formed on opposite sides thereof to be connected to the circuit board 7, and a pair of relatively narrow terminals 2b disposed between the terminals 2a. The back shell 2 is further provided with a pair of fixed portions 2c formed on its opposite sides and having tap portions to receive the screws 3 inserted and screwed therein. The back shell 2 is provided with a press-fit portion 8 having opposite surfaces to be press-contacted to the contacting pieces 1d and 1d′ of the front shell 1. More particularly, the press-fit portion 8 is press fitted between the upper contacting piece 1d′ and a group of the lower contacting pieces 1d. Thus, the contacting pieces 1d and 1d′ are elastically contacted with the press-fit portions 8.

The housing 5 has a pair of flange portions 5a integrally formed on its opposite sides and clamped between the fixing portions 1b of the front shell 1 and the fixed portions 2c of the back shell 2. Each of the flange portions 5a has a groove 5b for positioning the fixed portions 2c. By screwing the screws 3 through the insertion holes 1c to the tap portions 2d, the front shell 1 and the back shell 2 are fixed to the housing 5.

Each of the contacting pieces 1d located on a relatively lower side in FIG. 2B is bent at its end so as to surround an upper end of the flange portion 5a and an upper end of the fixed portion 2c, as illustrated in FIG. 5B. As a consequence, the fixed portion 2c is locked to the flange portion 5a by the contacting portion 1d and the groove 5b. Simultaneously, the contacting piece 1d is contacted with the fixed portion 2c.

In the above-mentioned connector, the hooked terminals 1a of the front shell 1 and the four terminals 2a and 2b of the back shell 2 contributes to connection with the circuit board, together with the contacts 4. By the screws 3, the front shell 1 and the back shell 2 are fixed to the housing 5.

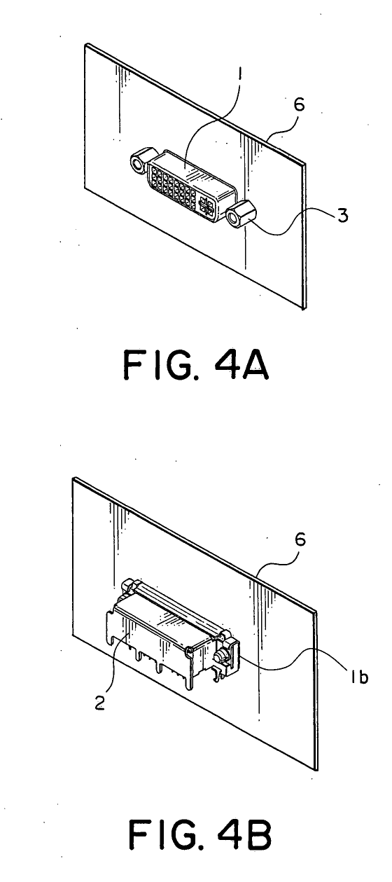

Referring to FIGS. 4A, 4B, 5A, and 5B, a casing panel or a chassis panel 6 is included in an electric or electronic apparatus and clamped between the fixing portions 1b of the front shell 1 and the screws 3. In order to attach the connector to the chassis panel 6, the screws 3 are screwed into the tap portions 2d of the back shell 2 through the insertion holes 1c of the front shell 1 and insertion holes (not shown) of the chassis panel 6. As a result, the chassis panel 6 is steadily clamped between the fixing portions 1b of the front shell 1 and the screws 3.

In this state, a part of the front shell 1, the fitting portion 51 of the housing 5 (i.e., a portion to be fitted to a mating connector), and a main body of each of the screws 3 are exposed outside the chassis panel 6. Inside the chassis panel 6, the back shell 2 covering the angled portions 4a of the contacts 4 in the housing 5, the terminals 2a and 2b, and the fixed portions 2c, the flange portions 5a of the housing 5, a connected portion of each contact 4, and a threaded portion of each screw 3 are disposed.

In the above-mentioned connector, the hooked terminals 1a contributing to connection with the circuit board 7 are integrally formed on the front shell 1. Therefore, no separate component for grounding is required so that the number of components is reduced and assembling does not require a lot of time and labor (a number of steps). This means that the connector can be produced at a low cost. Thus, cost improvement is achieved.

The chassis panel 6 is clamped between the fixing portions 1b of the front shell 1 and the screws 3. The back shell 2 is connected and fixed by the screws 3. The terminals (the hooked terminals 1a of the front shell 1 and the terminals 2a and 2b of the back shell 2) contributing to connection with the circuit board 7 are integrally formed on the front shell 1 and the back shell 2, respectively. The front shell 1 is provided with the contacting pieces 1d and 1d′ formed integral therewith and adapted be elastically connected to the back shell 2. Therefore, an electric loop is formed in each of the front shell 1 and the back shell 2 so that no reflection of a grounding signal is caused. Thus, a whole of the connector is strongly shielded as the connector of a shield-enhanced type with a simple structure.

In order to attach the connector to the chassis panel 6, the screws 3 are inserted through the insertion holes 1c of the front shell 1 and the insertion holes of the chassis panel 6 to be fastened to the tap portions 2d of the back shell 2. In this manner, the chassis panel 6 is clamped between the fixing portions 1b of the front shell 1 and the screws 3. As a consequence, the back shell 2 is applied with a load so that the back shell 2 is drawn towards the chassis panel 6. Simultaneously, the front shell 1 and the housing 5 are also applied with a load towards the chassis panel 6. Therefore, the connecting strength between the front shell 1 and the housing 5 as well as the connecting strength between the front shell 1 and the back shell are stably maintained so that the mechanical strength is remarkably improved. In addition, the front shell 1 is also applied with a load towards the chassis panel 6. Therefore, tight contact between the chassis panel 6 and the front shell 1 is improved so that mounting and fixing operations can stably be carried out.

The number and the shape of the terminals for grounding the front shell 1 and the back shell 2 may be appropriately modified as desired.

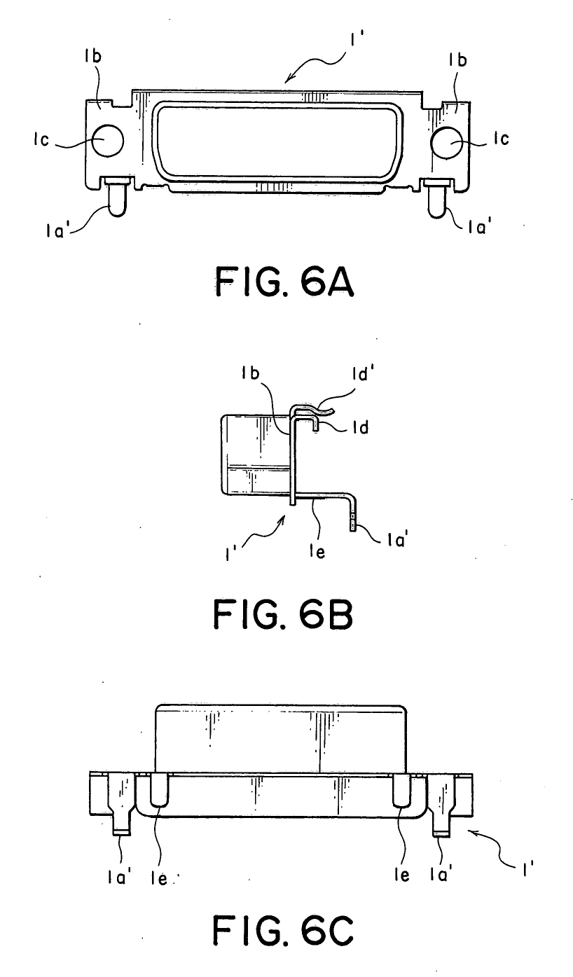

Referring to FIGS. 6A through 6C, a modification of the front shell 1 will be described. Similar parts are designated by like reference numerals and will not be described.

The front shell 1′ in FIGS. 6A through 6C has a pair of terminals 1a′ having a generally L-shaped section, instead of the hooked terminals 1a of the front shell 1 in FIGS. 2A through 2C. The front shell 1′ having the above-mentioned structure also has the insertion holes 1c formed in the fixing portions 1b. Therefore, the front shell 1′ can be connected and fixed to the back shell 2 or 2′ by fastening the screws 3 to the tap portions 2d of the fixed portions 2c or 2c′. Thus, the connector using the front shell 1′ in FIGS. 6A through 6C has a function and an effect equivalent to those of the connector in FIGS. 1A through 1C.

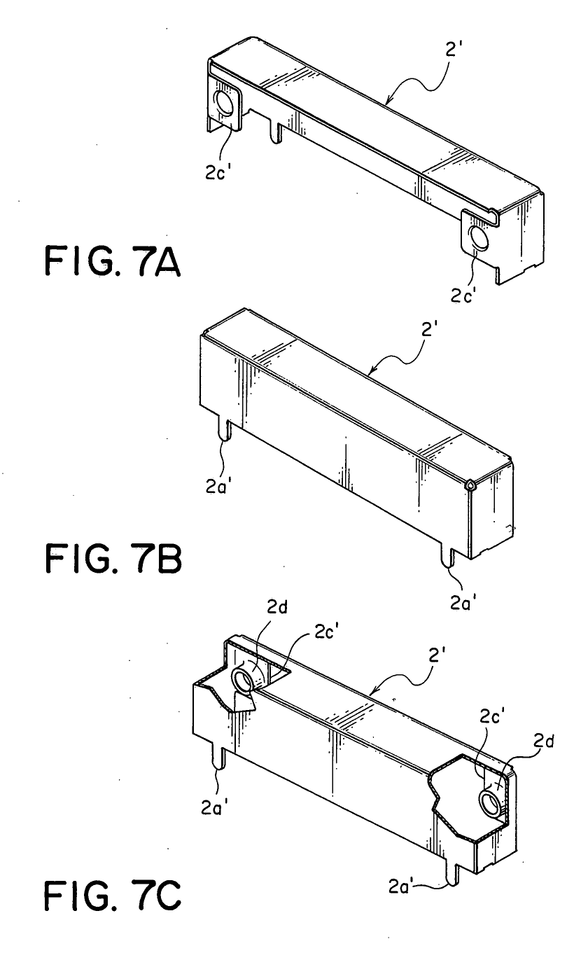

Referring to FIGS. 7A through 7C, a modification of the back shell 2 will be described. Similar parts are designated by like reference numerals and will not be described.

The back shell 2′ illustrated in FIGS. 7A through 7C is designed to be greater in size than the back shell 2 in FIGS. 3A through 3F in a left-to-right direction as seen from a front side. Further, the back shell 2′ has fixed portions 2c′ folded inside and a pair of terminals 2a′ formed at its lower end of opposite sides thereof. The back shell 2′ of the above-mentioned structure also has the tap portions 2d in the fixed portions 2c′. Therefore, by connecting and fixing the back shell 2′ to the front shell 1 by the use of the screws 3, the connector has a function and an effect equivalent to those of the connector in FIGS. 1A through 1C.

It will readily be understood that this invention is not restricted to the connector in the foregoing embodiment. For example, the housing 5 may not have the flange portions 5a so that the fixing portions 1b of the front shell 1 and the fixed portions 2c of the back shell 2 are directly contacted with each other. In this case, it is preferable that the contacting piece formed on at least one of the fixing portion 1b and the fixed portion 2c is changed in shape so that the fixing portion 1b and the fixed portion 2c are elastically contacted with each other. In case where a whole of the connector has a large size and a large mass (weight), the structure of the connector, including the number of the screws 3, may appropriately be changed. Further, in order to reliably fix the front shell 1 or 1′ and the back shell 2 or 2′, for example, a fixing member 2e may be formed at a predetermined position of the back shell 2 as illustrated in FIG. 3D. In addition, a fixing member 1e may be formed at a predetermined position of the front shell 1′ as illustrated in FIG. 6C so that the front shell and the back shell are fixed to each other by caulking the fixing members 1e and 2e of one of the shells to the other.

The connector of this invention is sufficiently enhanced in connecting strength between the front shell and the back shell and in shielding function and has a simple structure assuring a stable operation in mounting the connector to the circuit board and in attaching the connector to the chassis panel. Thus, the connector of this invention is particularly suitable as a high-frequency connector, such as a DVI connector, an infiniband connector, and a PCI connector, which requires suppression of noise due to electromagnetic interference (EMI protection) and an excellent shielding function.

While this invention has thus far been described in conjunction with the preferred embodiment thereof, it will be readily possible for those skilled in the art to put this invention into practice in various other manners.

1. A connector to be mounted to a board, said connector comprising:
a contact having an angled portion;
a housing having a fitting portion and fixedly holding said contact; and
a shell being conductive, said shell including a front shell covering said fitting portion and a back shell covering said angled portion, said front shell having a terminal to be connected to said board and a fixing portion provided with an insertion hole allowing a screw to be inserted therethrough, said back shell having a terminal to be connected to said board and a fixed portion faced to said fixing portion, said fixed portion having a tap portion, said front and said back shells being fixed to said housing by screwing said screw through said insertion hole into said tap portion.

2. The connector according to claim 1, wherein said housing has a flange portion clamped between said fixing portion and said fixed portion.

3. The connector according to claim 1, wherein said terminal of the front shell has a hook portion to be engaged with said board.

4. The connector according to claim 1, wherein at least one of said front and said back shells has a contacting portion to be elastically contacted with the other.

5. The connector according to claim 4, wherein said contacting portion has a plurality of contacting pieces which are divided into two groups, the other of said front and said back shells having a press-fit portion press-fitted between said two groups.

6. The connector according to claim 5, wherein said contacting portion is formed on said front shell and has a contacting piece to be engaged with said fixed portion.

7. The connector according to claim 4, wherein said contacting portion is formed on said front shell, said front shell having a fixing member clamping said housing in cooperation with said contacting portion.

8. The connector according to claim 1, wherein said back shell has a fixing member to be engaged with said housing.
